(19) United States
(12) Patent Application Publication
(10) Pub. No.: US 2026/0030449 A1
(43) Pub. Date: Jan. 29, 2026

(54) DOCUMENT MANAGEMENT SYSTEM, KEYWORD DETECTION PROGRAM, AND DOCUMENT MANAGEMENT PROGRAM

(71) Applicant: KYOCERA DOCUMENT SOLUTIONS INC., OSAKA (JP)

(72) Inventors: YUYA KUBO, OSAKA (JP); DAISUKE YOSHIDA, OSAKA (JP)

(21) Appl. No.: 19/278,801

(22) Filed: Jul. 24, 2025

(30) Foreign Application Priority Data
Jul. 25, 2024 (JP) 2024-119334

(51) Int. Cl. G06F 40/279; G06F 21/62

(52) U.S. Cl. CPC G06F 40/279; G06F 21/6209

(57) ABSTRACT

A document management system that manages a document includes a keyword detection unit. The keyword detection unit detects a keyword included in an uploaded document that is the document uploaded to the document management system. The keyword detection unit executes notification to a specific notification destination that is a specified notification destination in a case where the keyword is included in the uploaded document under a specific condition that is a specified condition. At least one of the specific conditions is a condition that all multiple specific keywords that are a plurality of the keywords specified are included in the uploaded document.

### CROSS-REFERENCE TO RELATED PATENT APPLICATION

This application claims the benefit of Japanese Priority Patent Application JP 2024-119334 filed Jul. 25, 2024, the entire contents of which are incorporated herein by reference.

### FIELD OF THE DISCLOSURE

The present disclosure relates to a document management system, a keyword detection program, and a document management program for managing documents.

### BACKGROUND OF THE DISCLOSURE

In the related art, a terminal that checks a collection of keywords related to confidential information against the contents of a document to be uploaded to a network storage apparatus, thereby detecting whether or not the document to be uploaded to the network storage apparatus includes the confidential information is known (e.g., see Japanese Patent No. 5186363).

### SUMMARY OF THE DISCLOSURE

A document management system according to the present disclosure is a document management system that manages a document and includes a keyword detection unit. The keyword detection unit detects a keyword included in an uploaded document that is the document uploaded to the document management system. The keyword detection unit executes notification to a specific notification destination that is a specified notification destination in a case where the keyword is included in the uploaded document under a specific condition that is a specified condition. At least one of the specific conditions is a condition that all multiple specific keywords that are a plurality of the keywords specified are included in the uploaded document.

A keyword detection program according to the present disclosure is a keyword detection program that causes a document management system to realize a keyword detection unit that detects a keyword included in an uploaded document that is a document uploaded to a document management system that manages the document. The keyword detection unit executes notification to a specific notification destination that is a specified notification destination in a case where the keyword is included in the uploaded document under a specific condition that is a specified condition. At least one of the specific conditions is a condition that all multiple specific keywords that are a plurality of the keywords specified are included in the uploaded document.

A document management program according to the present disclosure is a document management program that causes a computer to realize a document management and a keyword detection unit. The document management unit manages a document. The keyword detection unit detects a keyword included in an uploaded document that is the document uploaded to the document management unit. The keyword detection unit executes notification to a specific notification destination that is a specified notification destination in a case where the keyword is included in the uploaded document under a specific condition that is a specified condition. At least one of the specific conditions is a condition that all multiple specific keywords that are a plurality of the keywords specified are included in the uploaded document.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a block diagram of a system according to an embodiment of the present disclosure.

FIG. 2 is a block diagram of an example of a document management system shown in FIG. 1 in a case where it is constituted by a single computer.

FIG. 3 is a diagram showing an example of user management information shown in FIG. 2.

FIG. 4 is a diagram showing an example of group management information shown in FIG. 2.

FIG. 5 is a diagram showing an example of document management information shown in FIG. 2.

FIG. 6 is a diagram showing an example of keyword management information shown in FIG. 2.

FIG. 7 is a diagram showing an example of alert mail management information shown in FIG. 2.

FIG. 8 is a block diagram of an example of a user terminal shown in FIG. 1 in a case where it is constituted by a PC.

FIG. 9 is a block diagram of an example of a manager terminal shown in FIG. 1 in a case where it is constituted by a PC.

FIG. 10 is a sequence diagram of an operation of the system shown in FIG. 1 in a case where a user logs in the document management system through the user terminal.

FIG. 11 is a sequence diagram of an operation of the system shown in FIG. 1 in a case where a keyword is registered in the document management system.

FIG. 12 is a diagram showing an example of a keyword registration page displayed in the operation shown in FIG. 11.

FIG. 13 is a sequence diagram of an operation of the system shown in FIG. 1 in a case where a document is uploaded to the document management system.

FIG. 14 is a flowchart of an operation of the document management system shown in FIG. 2 in a case of detecting the keyword from the document.

FIG. 15 is a diagram showing an example of the body of an alert mail sent in the operation shown in FIG. 14.

FIG. 16 is a sequence diagram of an operation of the system shown in FIG. 1 in a case where the document is viewed.

FIG. 17 is a sequence diagram of an operation of the system shown in FIG. 1 in a case where the document is approved.

FIG. 18 is a flowchart of an operation of the document management system shown in FIG. 2 in a case where the document is approved.

### DETAILED DESCRIPTION OF THE EXEMPLARY EMBODIMENTS

Hereinafter, an embodiment of the present disclosure will be described with reference to the drawings.

First of all, a configuration of a system according to the embodiment of the present disclosure will be described.

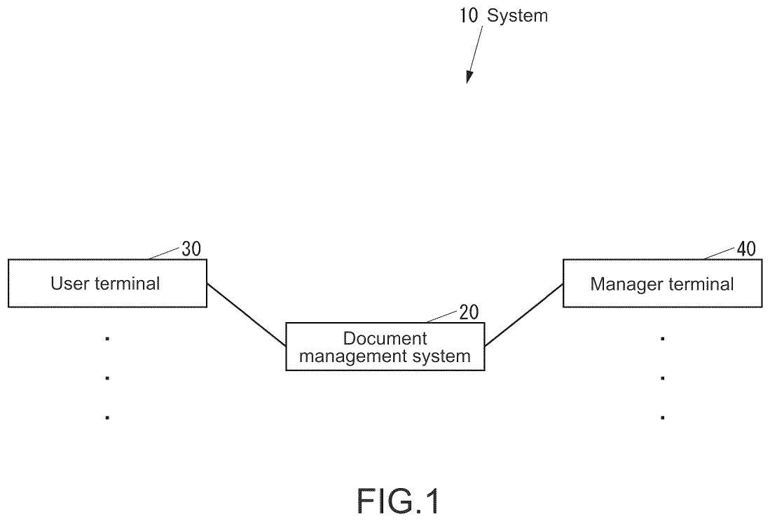

FIG. 1 is a block diagram of a system 10 according to the present embodiment.

As shown in FIG. 1, the system 10 includes a document management system 20 that manages a document. For example, the document management system 20 may be constituted by a single computer, such as a personal computer (PC), or may be constituted by multiple computers. For example, the document management system 20 may be realized by on-premise or may be realized by a cloud.

The system 10 includes a terminal (hereinafter, referred to as “user terminal”) 30 used by users of the document management system 20. The system 10 may include at least one user terminal similar to the user terminal 30 in addition to the user terminal 30. For example, the user terminal may be constituted by a PC.

The system 10 includes a terminal (hereinafter, referred to as “manager terminal”) 40 used by a manager of the document management system 20, who manage the document management system 20. The system 10 may include at least one manager terminal similar to the manager terminal 40 in addition to the manager terminal 40. For example, the manager terminal may be constituted by a PC.

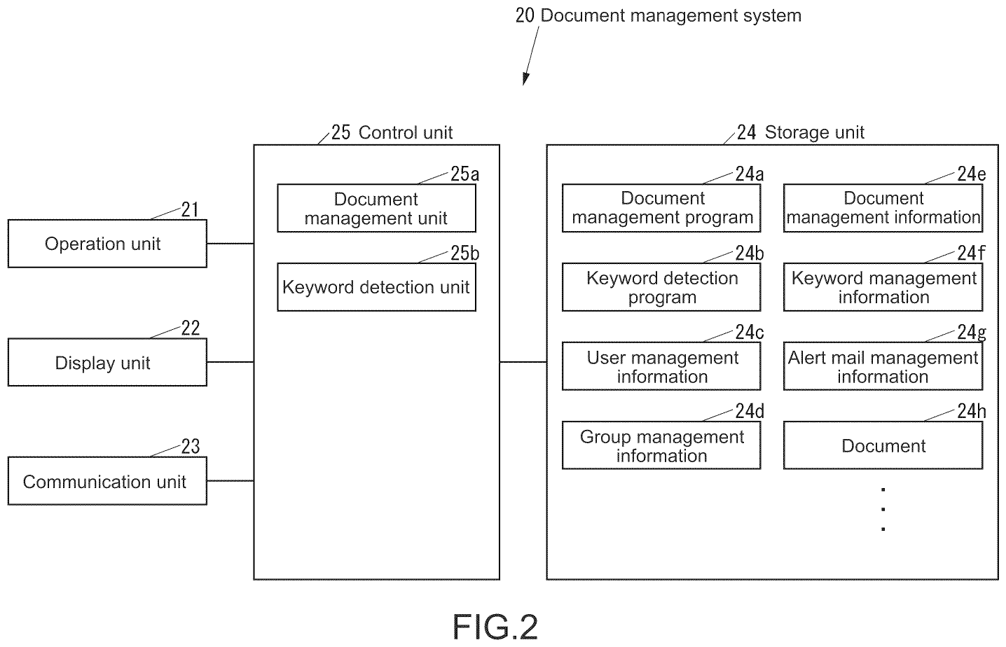

FIG. 2 is a block diagram of an example of the document management system 20 in a case where it is constituted by a single computer.

As shown in FIG. 2, the document management system 20 includes an operation unit 21, a display unit 22, a communication unit 23, a storage unit 24, and a control unit 25. The operation unit 21 is an operation device to which various operations are input, such as keyboard and mouse. The display unit 22 is a display device that displays various types of information, such as a liquid crystal display (LCD). The communication unit 23 is a communication device that communicates with an external apparatus via a network, such as a local area network (LAN) or Internet, or directly with a wire or wirelessly without the network. The storage unit 24 is a nonvolatile storage device that stores various types of information, such as a semiconductor memory or a hard disk drive (HDD). The control unit 25 comprehensively controls the document management system 20.

The storage unit 24 is capable of storing a document management program 24a for managing documents. For example, the document management program 24a may be installed in the document management system 20 during the production phase of the document management system 20. Alternatively, for example, the document management program 24a may be additionally installed in the document management system 20 from an external storage medium such as a universal serial bus (USB) memory. Alternatively, for example, the document management program 24a may be additionally installed in the document management system 20 from the network.

The storage unit 24 is capable of storing a keyword detection program 24b for detecting a keyword included in a document uploaded to the document management system 20. For example, the keyword detection program 24b may be installed in the document management system 20 during the production phase of the document management system 20. Alternatively, for example, the keyword detection program 24b may be additionally installed in the document management system 20 from an external storage medium such as a USB memory. Alternatively, for example, the keyword detection program 24b may be additionally installed in the document management system 20 from the network.

The storage unit 24 is capable of storing user management information 24c that manages the users of the document management system 20.

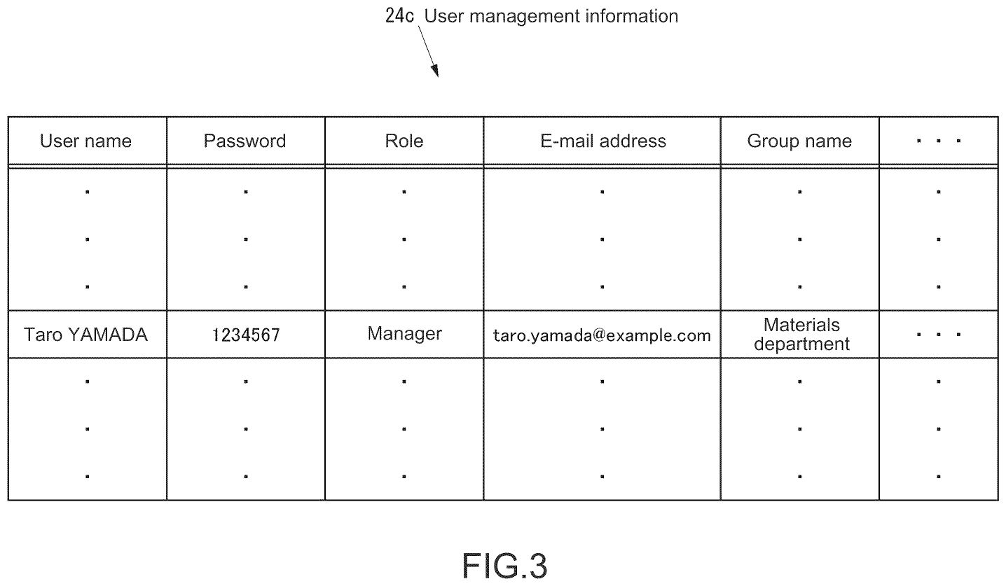

FIG. 3 is a diagram showing an example of the user management information 24c.

The user management information 24c shown in FIG. 3 includes, for each user, a user name that is identification information of the user, a password of the user, a role of the user, an e-mail address of the user, and a group name that is identification information of the group to which the user belongs. For example, the role includes a general user as a general user of the document management system 20 and a manager. The user management information 24c shown in FIG. 3 is depicted with some information omitted.

As shown in FIG. 2, the storage unit 24 is capable of storing group management information 24d that manages groups.

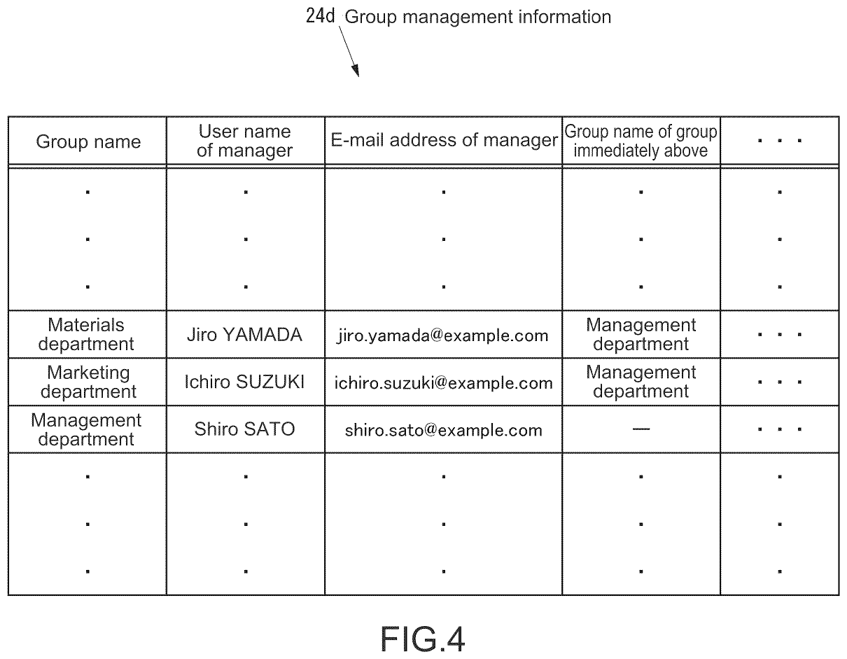

FIG. 4 is a diagram showing an example of the group management information 24d.

The group management information 24d shown in FIG. 4 includes, for each group, a group name, a user name of a manager belonging to the group, an e-mail address of this manager, and a group name of a group immediately above the group. The group management information 24d shown in FIG. 4 is depicted with some information omitted.

As shown in FIG. 2, the storage unit 24 is capable of storing document management information 24e for managing documents.

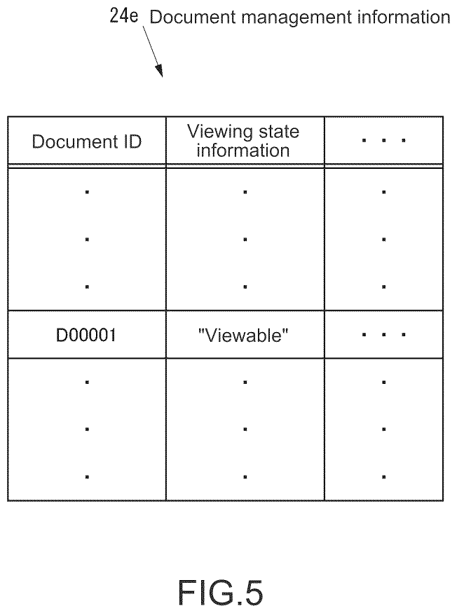

FIG. 5 is a diagram showing an example of the document management information 24e.

The document management information 24e shown in FIG. 5 includes, for each document, a document ID that is identification information of the document and viewing state information indicating whether or not the document is viewable. The value of the viewing state information is “viewable” indicating that the document is viewable or “not viewable” indicating that the document is not viewable. The document management information 24e shown in FIG. 5 is depicted with some information omitted.

As shown in FIG. 2, the storage unit 24 is capable of storing keyword management information 24f that manages keywords to be detected.

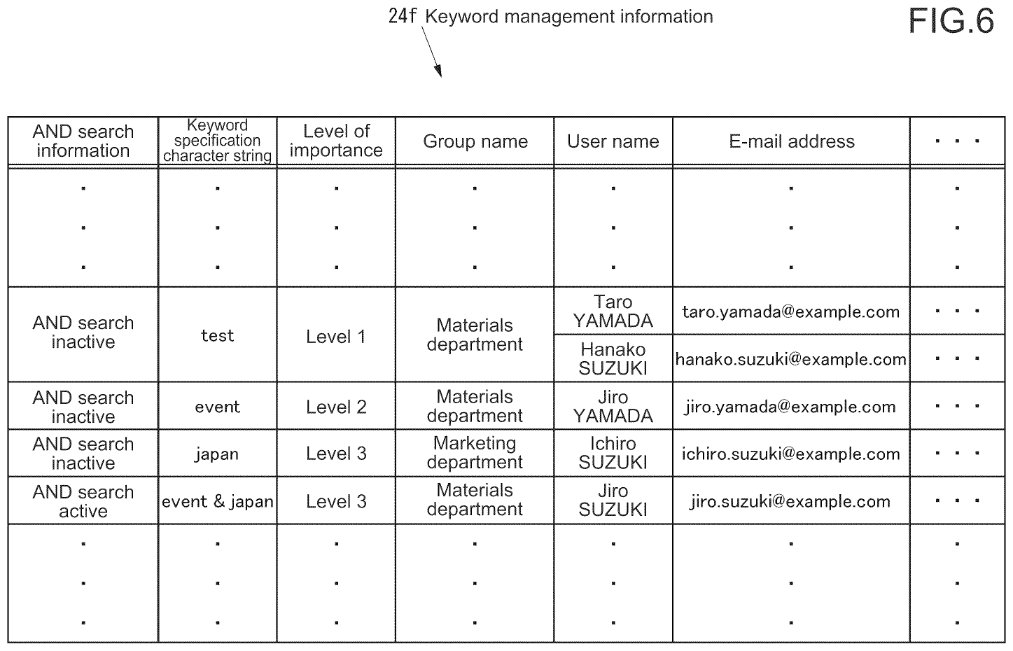

FIG. 6 is a diagram showing an example of the keyword management information 24f.

The keyword management information 24f shown in FIG. 6 includes, for each keyword specification character string, AND search information indicating whether or not to activate AND search using each of a plurality of character strings obtained by separating the keyword specification character string by “&” as keywords in a case where a keyword specification character string that is a character string for specifying keywords includes “&” that is a specified character string, the keyword specification character string, levels of importance of the keywords, and a group name of a group associated with the keywords, a user name that is a destination of an e-mail (hereinafter, referred to as “alert mail”), which is sent in a case where a keyword is detected, and an e-mail address that is a destination of the alert mail. The value of the AND search information is “AND search active” indicating that AND search for a plurality of keywords obtained by separating the keyword specification character string by “&” in a case where the keyword specification character string includes “&” is active or “AND search inactive” indicating that AND search for a plurality of keywords obtained by separating the keyword specification character string by “&” in a case where the keyword specification character string includes “&” is inactive. The combination of the AND search information and the keyword specification character string indicates a condition for determining that the keywords are included in the document. The keyword management information 24f shown in FIG. 6 can include multiple destinations of the alert mail for each keyword specification character string. FIG. 6 shows, as the levels of importance, Level 1 that is the lowest level of importance, Level 2 that is a level of importance higher than Level 1, and Level 3 that is a level of importance higher than Level 2. The keyword management information 24f shown in FIG. 6 is depicted with some information omitted.

As shown in FIG. 2, the storage unit 24 is capable of storing alert mail management information 24g that manages alert mails.

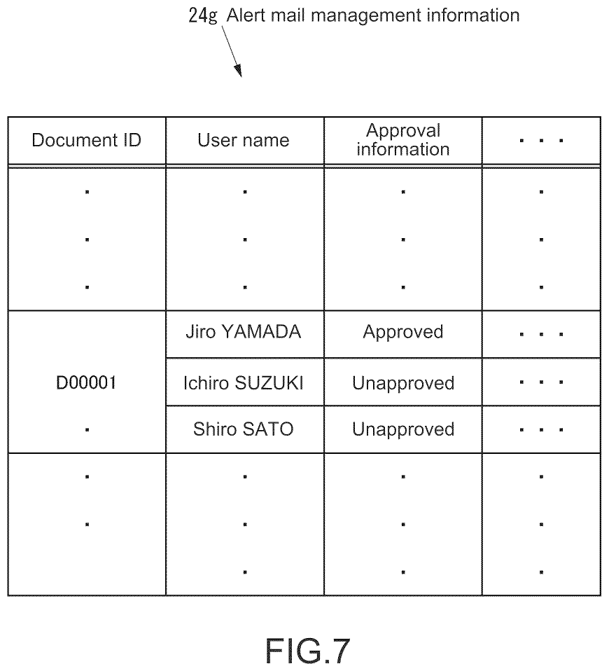

FIG. 7 is a diagram showing an example of the alert mail management information 24g.

The alert mail management information 24g shown in FIG. 7 includes, for each document ID, a document ID of a document for which the alert mail should be sent, a user name that is a destination of the alert mail, and approval information indicating whether or not the user who is the destination of the alert mail has approved the document for which the alert mail should be sent. The value of the approval information is “approved” indicating that the user who is the destination of the alert mail has approved the document for which the alert mail should be sent or “unapproved” indicating that the user who is the destination of the alert mail has not approved the document for which the alert mail should be sent. The alert mail management information 24g shown in FIG. 7 can include multiple user names that are destinations of the alert mail and multiple pieces of approval information for each document ID. The alert mail management information 24g shown in FIG. 7 is depicted with some information omitted.

As shown in FIG. 2, the storage unit 24 is capable of storing a document 24h. The storage unit 24 may be capable of storing at least one document in addition to the document 24h.

For example, the control unit 25 shown in FIG. 3 includes a central processing unit (CPU), a read only memory (ROM) that stores programs and various data, and a random access memory (RAM) that is a memory used as a working area for the CPU of the control unit 25. The CPU of the control unit 25 executes the programs stored in the storage unit 24 or the ROM of the control unit 25.

The control unit 25 realizes a document management unit 25a that manages documents by executing the document management program 24a.

The control unit 25 realizes a keyword detection unit 25b that detects the keyword included in the document uploaded to the document management system 20 by executing the keyword detection program 24b.

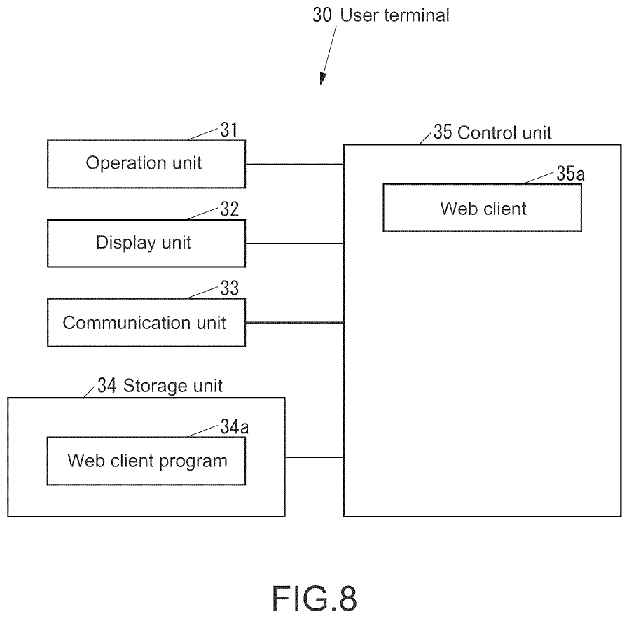

FIG. 8 is a block diagram of an example of the user terminal 30 in a case where it is constituted by a PC.

As shown in FIG. 8, the user terminal 30 includes an operation unit 31, a display unit 32, a communication unit 33, a storage unit 34, and a control unit 35. The operation unit 31 is an operation device in which various operations are input, such as keyboard and mouse. The display unit 32 is a display device that displays various types of information, such as an LCD. The communication unit 33 is a communication device that communicates with an external apparatus via a network, such as a LAN or Internet, or directly with a wire or wirelessly not via the network. The storage unit 34 is a nonvolatile storage device that stores various types of information, such as a semiconductor memory or HDD. The control unit 35 comprehensively controls the user terminal 30.

The storage unit 34 is capable of storing a web client program 34a for a web client. For example, the web client program 34a may be installed in the user terminal 30 during the production phase of the user terminal 30. Alternatively, for example, the web client program 34a may be additionally installed in the user terminal 30 from an external storage medium such as a USB memory.

Alternatively, for example, the web client program 34a may be additionally installed in the user terminal 30 from the network.

For example, the control unit 35 includes a CPU, a ROM that stores programs and various data, and a RAM that is a memory used as a working area for the CPU of the control unit 35. The CPU of the control unit 35 executes the programs stored in the storage unit 34 or the ROM of the control unit 35.

The control unit 35 realizes a web client 35a by executing the web client program 34a.

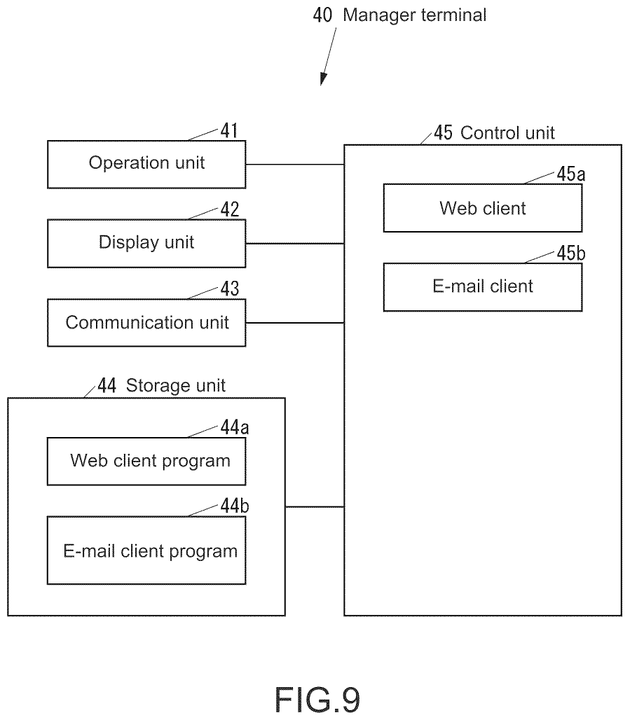

FIG. 9 is a block diagram of an example of the manager terminal 40 in a case where it is constituted by a PC.

As shown in FIG. 9, the manager terminal 40 includes an operation unit 41, a display unit 42, a communication unit 43, a storage unit 44, and a control unit 45. The operation unit 41 is an operation device in which various operations are input, such as keyboard and mouse. The display unit 42 is a display device that displays various types of information, such as an LCD. The communication unit 43 is a communication device that communicates with an external apparatus via a network, such as a LAN or Internet, or directly with a wire or wirelessly not via the network. The storage unit 44 is a nonvolatile storage device that stores various types of information, such as a semiconductor memory or HDD. The control unit 45 comprehensively controls the manager terminal 40.

The storage unit 44 is capable of storing a web client program 44a for a web client. For example, the web client program 44a may be installed in the manager terminal 40 during the production phase of the manager terminal 40. Alternatively, for example, the web client program 44a may be additionally installed in the manager terminal 40 from an external storage medium such as a USB memory. Alternatively, for example, the web client program 44a may be additionally installed in the manager terminal 40 from the network.

The storage unit 44 is capable of storing an e-mail client program 44b for an e-mail client. For example, the e-mail client program 44b may be installed in the manager terminal 40 during the production phase of the manager terminal 40. Alternatively, for example, the e-mail client program 44b may be additionally installed in the manager terminal 40 from an external storage medium such as a USB memory. Alternatively, for example, the e-mail client program 44b may be additionally installed in the manager terminal 40 from the network.

For example, the control unit 45 includes a CPU, a ROM that stores programs and various data, and a RAM that is a memory used as a working area for the CPU of the control unit 45. The CPU of the control unit 45 executes the programs stored in the storage unit 44 or the ROM of the control unit 45.

The control unit 45 realizes a web client 45a by executing the web client program 44a.

The control unit 45 realizes an e-mail client 45b by executing the e-mail client program 44b.

Next, an operation of the system 10 will be described.

Hereinafter, the user terminal 30 will be described, representing the user terminal. However, an user terminal other than the user terminal 30 is also capable of executing an operation similar to that of the user terminal 30. Similarly, hereinafter, the manager terminal 40 will be described, representing the manager terminal. However, a manager terminal other than the manager terminal 40 is also capable of executing an operation similar to that of the manager terminal 40.

First of all, an operation of the system 10 in a case where the user logs in the document management system 20 through the user terminal 30 will be described.

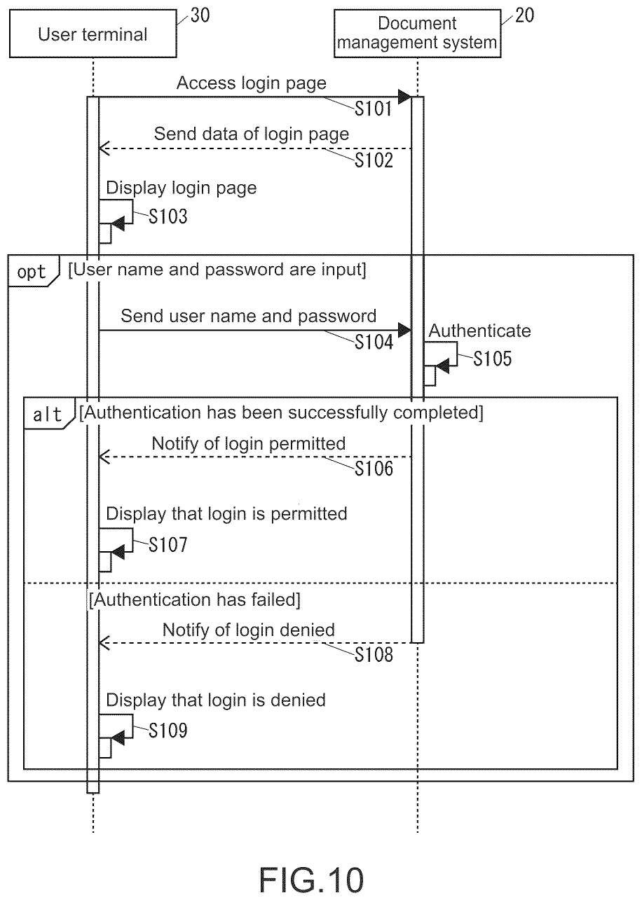

FIG. 10 is a sequence diagram of an operation of the system 10 in a case where the user logs in the document management system 20 through the user terminal 30.

The user is capable of instructing the user terminal 30 to access a login webpage provided by the document management system 20 (hereinafter, referred to as “login page”) through the web client 35a of the user terminal 30 via the operation unit 31 of the user terminal 30. When the web client 35a is instructed to access the login page, the web client 35a accesses the login page as shown in FIG. 10 (S101).

When the web client 35a accesses the login page, the document management unit 25a of the document management system 20 sends data of the login page to the web client 35a (S102).

When the web client 35a receives the data sent in S102, the web client 35a displays the login page on the display unit 32 on the basis of the received data (S103). Therefore, the user can input the user name and the password of the user to the login page displayed on the display unit 32.

When the user name and the password are input to the login page displayed on the display unit 32, the web client 35a sends the combination of the input user name and the password to the document management unit 25a (S104).

When the document management unit 25a receives the combination of the user name and the password sent from the web client 35a, the document management unit 25a performs authentication based on the combination of the user name and the password sent from the web client 35a (S105). Specifically, the document management unit 25a determines that the authentication has been successfully completed in a case where the combination of the user name and the password sent from the web client 35a is included in the user management information 24c. On the other hand, the document management unit 25a determines that the authentication has failed in a case where the combination of the user name and the password sent from the web client 35a is not included in the user management information 24c.

When the document management unit 25a determines in S105 that the authentication has been successfully completed, the document management unit 25a notifies the web client 35a of the user's login permitted (S106).

When the web client 35a receives the notification in S106, the web client 35a displays that the login has been permitted on the display unit 32 (S107).

When the document management unit 25a determines in S105 that the authentication has failed, the document management unit 25a notifies the web client 35a of the user's login denied (S108).

When the web client 35a receives the notification in S108, the web client 35a displays that the login has not been permitted on the display unit 32 (S109).

Hereinabove, the operation of the system 10 in a case where the user logs in the document management system 20 through the user terminal 30 has been described. However, the same applies to an operation of the system 10 in a case where the manager logs in the document management system 20 through the manager terminal 40.

Next, an operation of the system 10 in a case where a keyword is registered in the document management system 20 will be described.

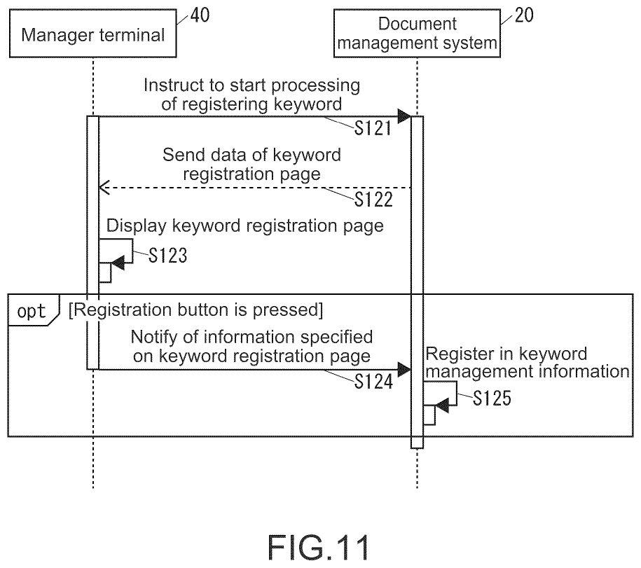

FIG. 11 is a sequence diagram of an operation of the system 10 in a case where a keyword is registered in the document management system 20.

In a case where the manager has logged into the document management system 20, the manager is capable of instructing the web client 45a of the manager terminal 40 to start processing of registering the keyword in the document management system 20. When the instruction to start the processing of registering the keyword in the document management system 20 has been made, the web client 45a instructs the document management system 20 to start the processing of registering the keyword as shown in FIG. 11 (S121).

When the instruction to start the processing of registering the keyword has been made, the keyword detection unit 25b of the document management system 20 sends data of a webpage registering the keyword (hereinafter, referred to as “keyword registration page”) to the web client 45a (S122).

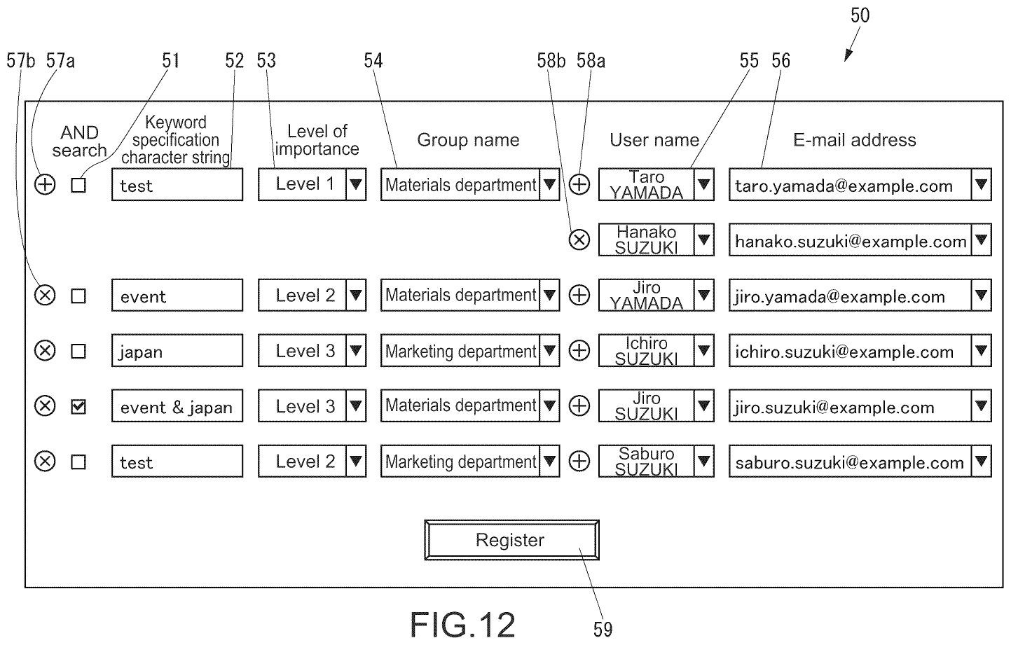

When the web client 45a receives the data sent in S122, the web client 45a displays a keyword registration page 50 (e.g., see FIG. 12) on the display unit 32 on the basis of the received data (S123).

FIG. 12 is a diagram showing an example of the keyword registration page 50.

The keyword registration page 50 shown in FIG. 12 includes, for each keyword, a check box 51, a text box 52, a drop down list 53, a drop down list 54, a drop down list 55, and a drop down list 56. The check box 51 is for specifying whether or not to activate AND search for a plurality of keywords obtained by separating the keyword specification character string by “&” in a case where the keyword specification character string includes “&.” The text box 52 is for inputting the keyword specification character string. The drop down list 53 is for selecting the level of importance for the keyword. The drop down list 54 is for selecting a group name of a group associated with the keyword. The drop down list 55 is for selecting a user name that is the destination of the alert mail. The drop down list 56 is for selecting an e-mail address that is the destination of the alert mail.

In a case where the manager wishes to activate AND search for a plurality of keywords obtained by separating the keyword specification character string by “&” in a case where the keyword specification character string includes “&,” it is sufficient that the manager checks the check box 51 and inputs the character string including “&” between the plurality of keywords to the text box 52.

The value that can be selected by the drop down list 54 is a group name included in the group management information 24d.

The value that can be selected by the drop down list 55 is the user name of the manager, which is associated in the user management information 24c with the group name selected by the drop down list 54.

The value selectable by the drop down list 56 is an e-mail address, which is associated in the user management information 24c with the user name selected by the drop down list 55.

The keyword registration page 50 includes an add button 57a and delete buttons 57b. The add button 57a is arranged on the left side of the check box 51 for the row of the keyword specification character string in the first row to add a row of the keyword specification character string. The delete buttons 57b are each arranged on the left side of the check box 51 for each row of the keyword specification character string in the second row and the subsequent rows to delete the row of the keyword specification character string.

On the keyword registration page 50, multiple combinations of user names and e-mail addresses may be registered with respect to the same combination of the keyword specification character string and the group name. The keyword registration page 50 shown in FIG. 12 includes add buttons 58a and an delete button 58b. The add buttons 58a are each arranged on the left side of the drop down list 55 in the row of the row of the user name and the e-mail address in the first row of each keyword specification character string to add the row of the user name and the e-mail address with respect to each keyword specification character string. The delete button 58b is arranged on the left side of the drop down list 55 for each row of the user name and the e-mail address in the second row and the subsequent rows of each keyword specification character string to delete the row of the user name and the e-mail address with respect to each keyword specification character string.

The keyword registration page 50 includes a registration button 59 for registering the keyword.

As shown in FIG. 11, when the registration button 59 is pressed after the processing in S123 ends, the web client 45a notifies the keyword detection unit 25b of information specified on the keyword registration page 50 at a point of time at which the registration button 59 is pressed (S124).

When the keyword detection unit 25b receives the notification in S124, the keyword detection unit 25b registers the information notified in S124 in the keyword management information 24f (S125).

Next, an operation of the system 10 in a case where the document is uploaded to the document management system 20 will be described.

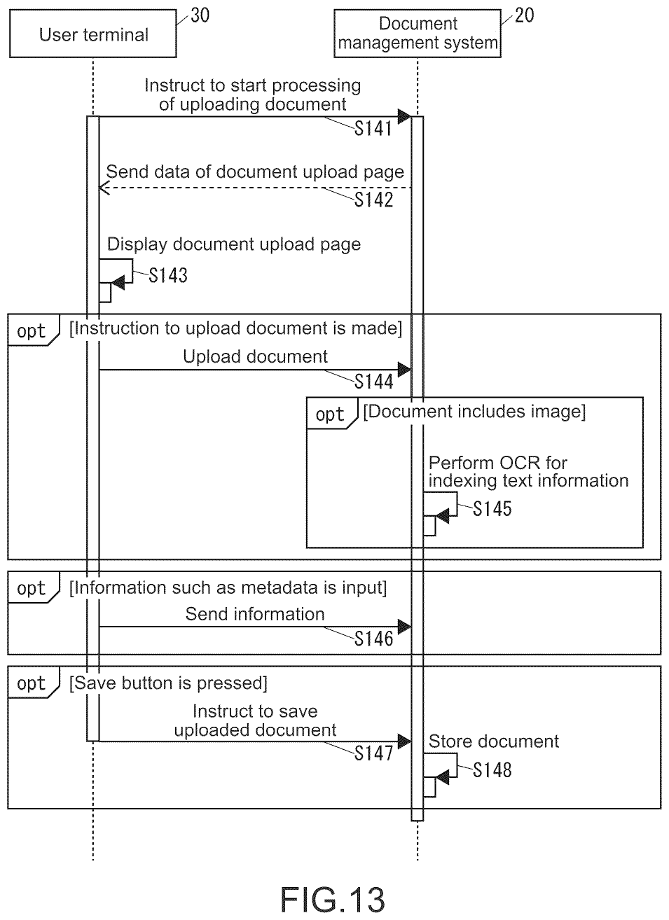

FIG. 13 is a sequence diagram of an operation of the system 10 in a case where the document is uploaded to the document management system 20.

In a case where the user has logged into the document management system 20, the user is capable of instructing the web client 35a of the user terminal 30 to start processing of uploading the document to the document management system 20. When the web client 35a is instructed to start processing of uploading the document to the document management system 20, the web client 35a instructs the document management system 20 to start processing of uploading the document as shown in FIG. 13 (S141).

When the document management unit 25a of the document management system 20 is instructed to the start of processing of uploading the document, the document management unit 25a of the document management system 20 sends data of a webpage for uploading the document (hereinafter, referred to as “document upload page”) to the web client 35a (S142).

When the web client 35a receives the data sent in S142, the web client 35a displays the document upload page on the display unit 32 on the basis of the received data (S143). The document upload page includes an operation unit (hereinafter, referred to as “upload operation unit”) that uploads the document to the document management system 20, an operation unit (hereinafter, referred to as “information input operation unit”) for inputting information such as metadata with respect to the document uploaded to the document management system 20, and a save button that is a button for saving the uploaded document in the document management system 20 in association with the input information.

When the web client 35a is instructed to upload a specific document from the user terminal 30 via the upload operation unit in the document upload page, the web client 35a uploads this document to the document management system 20 (S144).

When the document is uploaded in S144, the document management unit 25a of the document management system 20 executes optical character recognition (OCR) on the document for indexing text information (S145) in a case where the uploaded document includes an image. It should be noted that the document management unit 25a does not execute OCR, for example, in a case where the uploaded document is a document that includes text information, such as a text file, and does not include an image.

When information such as metadata with respect to the document uploaded to the document management system 20 is input on the document upload page via an information input unit after the processing in S144 ends, the web client 35a sends the input information to the document management system 20 (S146).

When the save button is pressed on the document upload page, the web client 35a instructs the document management system 20 to save the document uploaded to the document management system 20 in S144 (S147).

When the document management unit 25a of the document management system 20 receives the instruction in S147, the document management unit 25a of the document management system 20 stores the document, which has been uploaded to the document management system 20 in S144, in the storage unit 24 (S148). Here, in a case where the information is sent in S146, the document management unit 25a stores the information sent in S146 in the storage unit 24 in association with the document uploaded to the document management system 20 in S144.

Next, an operation of the document management system 20 in a case of detecting the keyword from the document will be described.

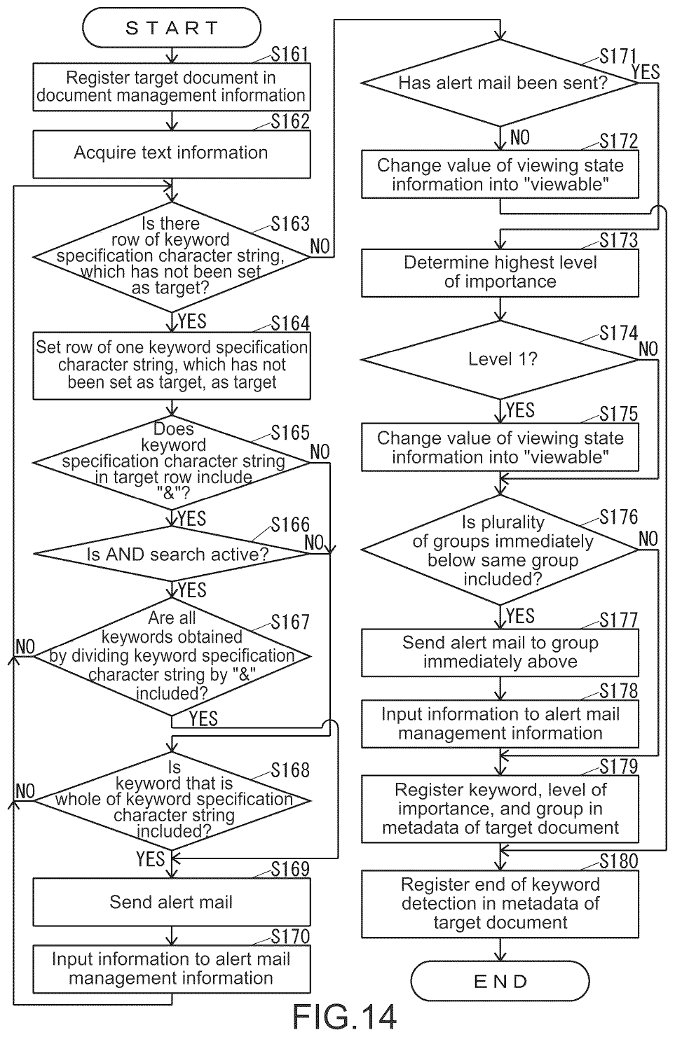

FIG. 14 is a flowchart of an operation of the document management system 20 in a case of detecting the keyword from the document.

The keyword detection unit 25b of the document management system 20 executes the operation shown in FIG. 14 when a document (hereinafter, referred to as “target document” in the description of the operation shown in FIG. 14) is stored in the storage unit 24.

As shown in FIG. 14, the keyword detection unit 25b registers the target document in the document management information 24e (S161). Here, the keyword detection unit 25b sets the value of the viewing state information associated with the target document in the document management information 24e to be “not viewable.”

When the processing of S161 ends, the keyword detection unit 25b acquires the text information of the target document (S162).

When the processing of S162 ends, the keyword detection unit 25b determines whether or not there is a row of the keyword specification character string, which has not been set as a target in this processing shown in FIG. 14, in the keyword management information 24f (S163).

When the keyword detection unit 25b determines in S163 that there is a row of the keyword specification character string, which has not been set as a target in this processing shown in FIG. 14, in the keyword management information 24f, the keyword detection unit 25b sets a row of one keyword specification character string of the rows of the keyword specification character strings stored in the keyword management information 24f, which has not been set as a target in this processing shown in FIG. 14, as a target (S164).

When the processing of S164 ends, the keyword detection unit 25b determines whether or not the keyword specification character string in the current target row includes “&” (S165).

When the keyword detection unit 25b determines in S165 that the keyword specification character string in the current target row includes “&,” the keyword detection unit 25b determines whether or not AND search for the value of the AND search information, which is associated with the current target row in the keyword management information 24f, is active (S166).

When the keyword detection unit 25b determines in S166 that AND search for the value of the AND search information, which is associated with the current target row in the keyword management information 24f, is active, the keyword detection unit 25b determines whether or not the text information acquired in S162 includes all the keywords obtained by separating the keyword specification character string in the current target row by “&” (S167). For example, in a case where the text information acquired in S162 is “This is sample file Japan event” and the keyword specification character string in the current target row is “event&japan,” “This is sample file Japan event” includes both “event” and “japan.” Therefore, the keyword detection unit 25b determines in S167 that the text information acquired in S162 includes all the keywords obtained by separating the keyword specification character string in the current target row by “&.”

When the keyword detection unit 25b determines in S165 that the keyword specification character string in the current target row does not include “&” or when the keyword detection unit 25b determines in S166 that AND search for the value of the AND search information, which is associated with the current target row in the keyword management information 24f, is inactive, the keyword detection unit 25b determines whether or not the text information acquired in S162 includes the keyword that is the whole of the keyword specification character string in the current target row (S168). For example, in a case where the text information acquired in S162 is “This is sample file Japan event” and the keyword specification character string in the current target row is “event&japan,” “This is sample file Japan event” does not include the character string, “event&japan.” Therefore, the keyword detection unit 25b determines in S168 that the text information acquired in S162 does not include the keyword that is the whole of the keyword specification character string in the current target row.

When the keyword detection unit 25b determines in S167 that the text information acquired in S162 includes all the keywords obtained by separating the keyword specification character string in the current target row by “&” or when the keyword detection unit 25b determines in S168 that the text information acquired in S162 includes the keyword that is the whole of the keyword specification character string in the current target row, the keyword detection unit 25b sends the alert mail to the e-mail address associated with the current target row in the keyword management information 24f (S169). Here, the keyword detection unit 25b sets the user name associated with the current target row in the keyword management information 24f as a user name that is the destination of the alert mail in S169.

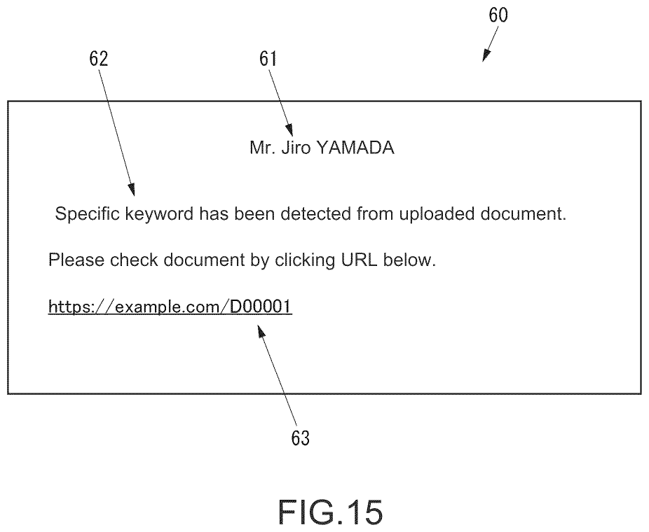

FIG. 15 is a diagram showing an example of a body 60 of the alert mail.

As shown in FIG. 15, the body 60 of the alert mail includes a text 61 indicating the user name that is the destination, a text 62 indicating that the keyword has been detected, and a link 63 indicating a location of the target document. The body 60 of the alert mail may include at least one of the detected keyword and the level of importance of the detected keyword.

As shown in FIG. 14, the keyword detection unit 25b inputs the information related to the alert mail sent in S169 to the alert mail management information 24g (S170). Here, a value of approval information newly input in S170 is “unapproved.”

When the keyword detection unit 25b determines in S167 that the text information acquired in S162 does not include at least one keyword obtained by separating the keyword specification character string in the current target row with “&,” when the keyword detection unit 25b determines in S168 that the text information acquired in S162 does not include the keyword that is the whole of the keyword specification character string in the current target row, or when the keyword detection unit 25b executes the processing in S170, the keyword detection unit 25b executes the processing in S163.

When the keyword detection unit 25b determines in S163 that there is a row of the keyword specification character string, which has not been set as a target in this processing shown in FIG. 14, in the keyword management information 24f, the keyword detection unit 25b determines whether or not the alert mail has been sent in this processing shown in FIG. 14 (S171).

When the keyword detection unit 25b determines in S171 that the alert mail has not been sent in this processing shown in FIG. 14, the keyword detection unit 25b changes the value of the viewing state information associated with the document management information 24e in the target document into “viewable” (S172).

When the keyword detection unit 25b determines in S171 that the alert mail has been sent in this processing shown in FIG. 14, the keyword detection unit 25b determines the highest level of importance among the levels of importance associated with the keyword detected from the target document in this processing shown in FIG. 14 in the keyword management information 24f (S173).

When the processing of S173 ends, the keyword detection unit 25b determines whether or not the level of importance determined in S173 is Level 1 (S174).

When the keyword detection unit 25b determines in S174 that the level of importance determined in S173 is Level 1, the keyword detection unit 25b changes the value of the viewing state information associated with the document management information 24e in the target document into “viewable” (S175).

When the keyword detection unit 25b determines in S174 that the level of importance determined in S173 is Level 1 or when the processing of S175 ends, the keyword detection unit 25b determines whether or not the group associated with each keyword detected from the target document in this processing shown in FIG. 14 in the keyword management information 24f includes a plurality of groups immediately below the same group (S176).

When the keyword detection unit 25b determines in S176 that the group associated with each keyword detected from the target document in this processing shown in FIG. 14 in the keyword management information 24f includes the plurality of groups immediately below the same group, the keyword detection unit 25b sends the alert mail to the e-mail address associated with the group immediately above these plurality of groups (hereinafter, referred to as “group immediately above”) in the group management information 24d (S177). Here, the keyword detection unit 25b sets the user name associated with the group immediately above in the group management information 24d as a user name that is the destination of the alert mail in S177.

When the processing of S177 ends, the keyword detection unit 25b inputs the information related to the alert mail sent in S177 to the alert mail management information 24g (S178). Here, a value of approval information newly input in S178 is “unapproved.”

When the keyword detection unit 25b determines in S176 that the group associated with each keyword detected from the target document in this processing shown in FIG. 14 in the keyword management information 24f does not include the plurality of groups immediately below the same group or when the processing of S178 ends, the keyword detection unit 25b registers, for each keyword detected from the target document in this processing shown in FIG. 14, the keyword detected from the target document in this processing shown in FIG. 14, the level of importance associated with this keyword in the keyword management information 24f, and the group associated with this keyword in the keyword management information 24f in metadata of the target document (S179).

When the processing of S172 or S179 ends, the keyword detection unit 25b registers the end of the keyword detection in the metadata of the target document (S180) and terminates the operation shown in FIG. 14.

Next, an operation of the system 10 in a case where the document is viewed will be described.

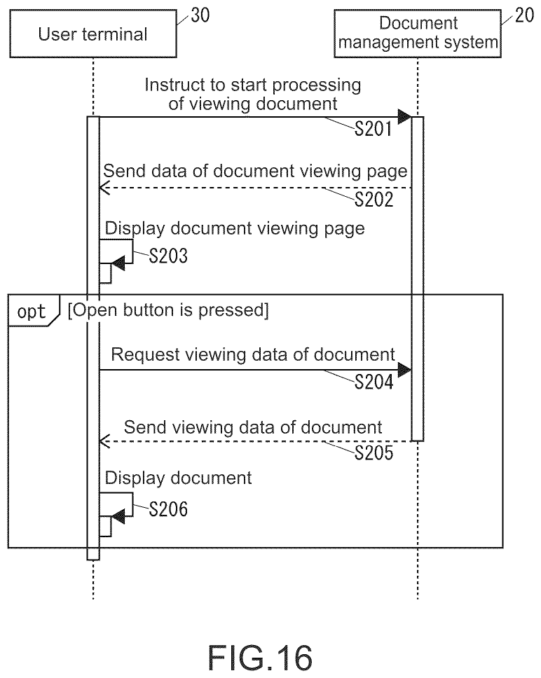

FIG. 16 is a sequence diagram of an operation of the system 10 in a case where the document is viewed.

In a case where the user has logged into the document management system 20, the user is capable of instructing the web client 35a of the user terminal 30 to start the processing of viewing the document. When the web client 35a is instructed to start the processing of viewing the document, the web client 35a instructs the document management system 20 to start the processing of viewing the document as shown in FIG. 16 (S201).

When the document management unit 25a of the document management system 20 is instructed to start the processing of viewing the document, the document management unit 25a of the document management system 20 sends data of a webpage for viewing the document (hereinafter, referred to as “document viewing page”) to the web client 35a (S202).

When the web client 35a receives the data sent in S202, the web client 35a displays the document viewing page on the display unit 32 on the basis of the received data (S203). The document viewing page includes a document list part and an open button. The document list part indicates a list of documents stored in the storage unit 24 of the document management system 20 and an open button for opening a document selected in the document list part. Regarding the document for which the value of the viewing state information is “not viewable” in the document management information 24e, the document management unit 25a of the document management system 20 sets this document to be grayed out and unselectable in the document list part on the document viewing page. That is, the document selectable in the document list part on the document viewing page is a document for which the value of the viewing state information is “viewable” in the document management information 24e.

When a document is selected in the document list part on the document viewing page and the open button is pressed after the processing in S203 ends, the web client 35a requests viewing data of the document selected in the document list part from the document management system 20 (S204).

When the document management unit 25a of the document management system 20 receives the request in S204, the document management unit 25a of the document management system 20 sends the viewing data requested in S204 to the web client 35a (S205).

When the web client 35a receives the viewing data sent in S205, the web client 35a displays the document on the display unit 32 on the basis of the received viewing data (S206). Therefore, the user can view the document displayed on the display unit 32.

Next, an operation of the system 10 in a case where the document is approved will be described.

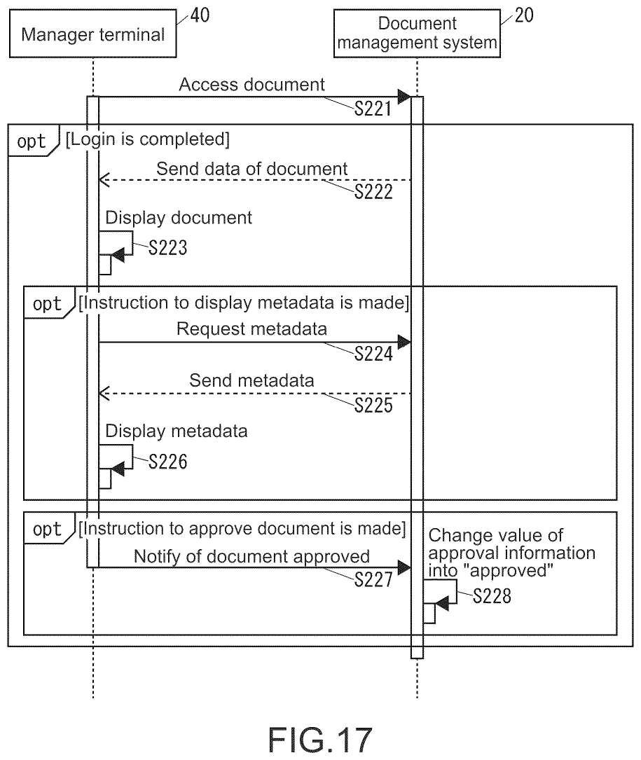

FIG. 17 is a sequence diagram of an operation of the system 10 in a case where the document is approved.

The manager is capable of receiving the alert mail through the e-mail client 45b of the manager terminal 40. Then, when the manager clicks a link included in the alert mail, the web client 45a of the manager terminal 40 accesses a document (hereinafter, referred to as “target document” in the description of the operation shown in FIG. 17) arranged in a location indicated by the link clicked by the manager as shown in FIG. 17 (S221). It should be noted that in a case where the manager accesses the target document via the web client 45a, the document management system 20 requests the manager to log in the document management system 20. Therefore, as described above, the manager logs in the document management system 20. A description of the series of login processing will be omitted.

When the manager's login to the document management system 20 has completed, the document management unit 25a of the document management system 20 sends data of the target document to the web client 45a (S222).

When the web client 45a receives the data sent in S222, the web client 45a displays the target document on the display unit 42 on the basis of the received data (S223). Therefore, the manager can view the target document displayed on the display unit 42.

The manager is capable of instructing the web client 45a to display the metadata of the target document via the operation unit 41. When the web client 45a is instructed to display the metadata of the target document, the web client 45a requests the metadata of the target document from the document management system 20 (S224).

When the document management unit 25a of the document management system 20 receives the request in S224, the document management unit 25a of the document management system 20 sends the metadata requested in S224 to the web client 45a (S225).

When the web client 45a receives the metadata sent in S225, the web client 45a displays the received metadata on the display unit 42 (S226). Therefore, the manager can view the metadata of the target document. For example, the manager is capable of checking a keyword detected from the target document by the document management system 20, a level of importance associated with this keyword, and a group associated with this keyword, for all keywords detected from the target document by the document management system 20. Moreover, the manager can also check the end of the keyword detection from the target document by the document management system 20.

The manager is capable of instructing the web client 45a to approve the target document via the operation unit 41. When the web client 45a is instructed to approve the target document, the web client 45a notifies the document management system 20 of the target document approved (S227).

When the document management unit 25a of the document management system 20 receives the notification in S227, the document management unit 25a of the document management system 20 changes the value of the approval information, which is associated in the alert mail management information 24g with the combination of the target document and the user name of the manager who has logged into the document management system 20 via the web client 45a, into “approved” (S228).

Next, an operation of the document management system 20 in a case where the document is approved will be described.

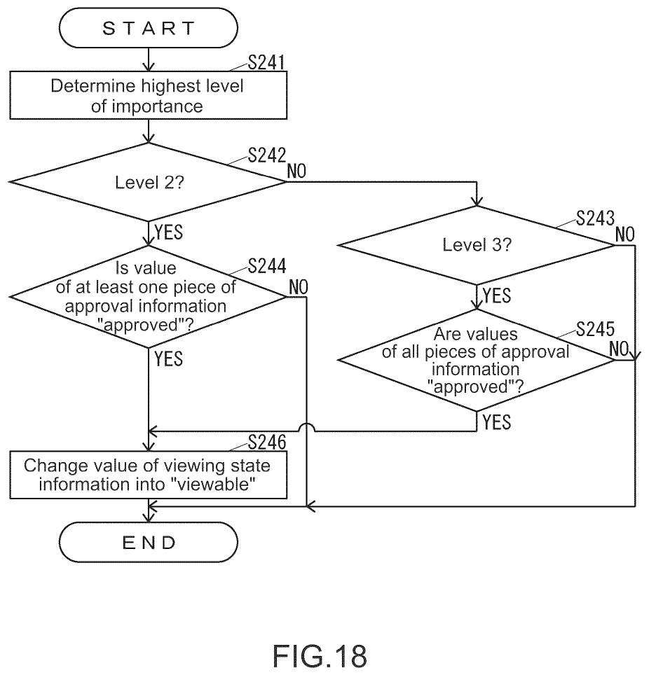

FIG. 18 is a flowchart of an operation of the document management system 20 in a case where the document is approved.

When the value of the approval information in the alert mail management information 24g is changed into “approved,” the keyword detection unit 25b of the document management system 20 executes the operation shown in FIG. 18.

As shown in FIG. 18, the keyword detection unit 25b determines the highest level of importance among the levels of importance included in the metadata of a document (hereinafter, referred to as “target document” in the description of the operation shown in FIG. 18) that is a target of the approval information, for which the value has been changed into “approved” (S241).

When the processing of S241 ends, the keyword detection unit 25b determines whether or not the level of importance determined in S241 is Level 2 (S242).

When the keyword detection unit 25b determines in S242 that the level of importance determined in S241 is not Level 2, the keyword detection unit 25b determines whether or not the level of importance determined in S241 is Level 3 (S243).

When the keyword detection unit 25b determines in S242 that the level of importance determined in S241 is Level 2, the keyword detection unit 25b determines whether or not the value of at least one piece of approval information associated with the target document in the alert mail management information 24g is “approved” (S244).

When the keyword detection unit 25b determines in S243 that the level of importance determined in S241 is Level 3, the keyword detection unit 25b determines whether or not values of all pieces of approval information associated with the target document in the alert mail management information 24g are “approved” (S245).

When the keyword detection unit 25b determines in S244 that the value of the at least one piece of approval information associated with the target document in the alert mail management information 24g is “approved” or when the keyword detection unit 25b determines in S245 that all values of the approval information associated with the target document in the alert mail management information 24g is “approved,” the keyword detection unit 25b changes the value of the viewing state information associated with the target document in the document management information 24e into “viewable” (S246).

When the keyword detection unit 25b determines in S243 that the level of importance determined in S241 is not Level 3, when the keyword detection unit 25b determines in S244 that all values of the approval information associated with the target document in the alert mail management information 24g are “unapproved,” when the keyword detection unit 25b determines in S245 that the value of the at least one piece of approval information associated with the target document in the alert mail management information 24g is “unapproved,” or when the processing of S246 ends, the keyword detection unit 25b terminates the operation shown in FIG. 18.

As described above, the document management system 20 executes notification to the specific notification destination in a case where the uploaded document includes all the plurality of specific keywords (YES in S167) (S169). It is thus possible to allow the user to recognize that the uploaded document includes the specific keywords.

The document management system 20 switches between executing notification to the specific notification destination (S169) in a case where all a plurality of character strings obtained by separating the keyword specification character string by “&” is included in the document (YES in S167) and executing notification to the specific notification destination (S169) in a case where the whole of the keyword specification character string is included in the document (YES in S168) in accordance with the user's instruction (the check box 51 (see FIG. 12) and S166). It is thus possible to enhance the convenience.

A notification destination when the document management system 20 executes notification in a case where the keyword is included in the document under a specific condition represented by a particular combination of the AND search information and the keyword specification character string is set for each specific condition. It is thus possible to execute notification to a notification destination according to the keyword. As a result, it is possible to enhance the convenience.

In a case where an uploaded document not viewable except by a plurality of specific users is approved by the number of specific users depending on the highest level of importance among the levels of importance set to each of all the specific conditions satisfied by the uploaded document (YES in S244 or YES in S245), the document management system 20 sets the uploaded document to be viewable (S246). It is thus possible to reduce the possibility that users other than the specific users view the document that may have high confidentiality.

In a case where a plurality of groups immediately below a specific group is associated with any one of the specific conditions satisfied by the uploaded document (YES in S176), the document management system 20 executes notification also to a notification destination of the specific group (S177). It is thus possible to enhance the convenience.

In the document management system 20, as shown in FIG. 6, the notification destination of the alert mail is set for each row of the keyword specification character string in the keyword management information 24f. However, in the document management system 20, the notification destination of the alert mail may be set for each level of importance set to the row of the keyword specification character string. In a case where the notification destination of the alert mail is set for each level of importance set to the row of the keyword specification character string, the document management system 20 is capable of executing notification to a notification destination depending on the level of importance of the keyword. As a result, it is possible to enhance the convenience.

In the present embodiment, in a case where the highest level of importance associated with the keyword detected from the document is Level 3, the document management system 20 sets this document to be viewable when managers that are all destinations of the alert mails with respect to this document approve the document. Moreover, in the present embodiment, in a case where the highest level of importance associated with the keyword detected from the document is Level 2, the document management system 20 sets this document to be viewable when a manager that is at least one destination of all destinations of the alert mails with respect to this document approves the document. Moreover, in the present embodiment, in a case where the highest level of importance associated with the keyword detected from the document is Level 1, the document management system 20 sets this document to be viewable irrespective of whether or not a manager(s) that is a destination(s) of the alert mail(s) with respect to this document approves the document. However, the document management system 20 may use may execute control other than such control by using the level of importance associated with the keyword detected from the document.

In the present embodiment, the levels of importance of the keywords are three levels. However, the levels of importance of the keywords may be multiple levels other than the three levels. Moreover, the system 10 does not need to employ the levels of importance of the keywords.

In the present embodiment, the document management system 20 employs “&” as a character string for dividing the keyword specification character string into the plurality of keywords for the AND search. However, the document management system 20 may employ a character string other than “&” as a character string for dividing the keyword specification character string into the plurality of keywords for the AND search.

In the present embodiment, the keyword detection program 24b exists separately from the document management program 24a. However, the keyword detection program 24b may be incorporated in the document management program 24a.

It should be understood by those skilled in the art that various modifications, combinations, sub-combinations and alterations may occur depending on design requirements and other factors insofar as they are within the scope of the appended claims or the equivalents thereof.

What is claimed is:

1. A document management system that manages a document, comprising
a keyword detection unit that detects a keyword included in an uploaded document that is the document uploaded to the document management system, wherein
the keyword detection unit executes notification to a specific notification destination that is a specified notification destination in a case where the keyword is included in the uploaded document under a specific condition that is a specified condition, and
at least one of the specific conditions is a condition that all multiple specific keywords that are a plurality of the keywords specified are included in the uploaded document.

2. The document management system according to claim 1, wherein
the keyword detection unit switches an interpretation of a keyword specification character string that is a character string for specifying the keyword in accordance with an instruction from a user, and
the keyword detection unit switches between
the interpretation that in a case where the keyword specification character string includes a specific character string that is a specified character string, each of a plurality of character strings obtained by separating the keyword specification character string by the specific character string is the keyword and a condition that all the multiple specific keywords that are the plurality of character strings are included in the uploaded document is the specific condition, and
the interpretation that even in a case where the keyword specification character string includes the specific character string, the whole of the keyword specification character string is the one keyword and a condition that the keyword that is the whole of the keyword specification character string is included in the uploaded document is the specific condition.

3. The document management system according to claim 1, wherein
the specific condition comprises multiple specific conditions, and
the specific notification destination is set for each of the specific conditions.

4. The document management system according to claim 1, wherein
a level of importance is set to the specific condition,
the keyword detection unit sets the uploaded document to be not viewable except by a specific user who is a specified user in a case where the keyword is included in the uploaded document under the specific condition,
the keyword detection unit sets the uploaded document to be viewable in a case where the uploaded document not viewable except by a plurality of the users specified is approved by the number of specific users depending on the highest level of importance among the levels of importance set to all the specific conditions satisfied by the uploaded document, and
the level of importance is higher as the number of persons is larger.

5. The document management system according to claim 1, wherein
the specific condition is associated with any one of groups to which any one of users of the document management system belongs, and
in a case where a plurality of the groups immediately below a specific group that is the group specified is associated with any one of the specific conditions satisfied by the uploaded document, the keyword detection unit includes a notification destination of the specific group in the specific notification destination.

6. The document management system according to claim 1, wherein
a level of importance is set to the specific condition, and
the specific notification destination is set for each level of importance.

7. A keyword detection program that causes a document management system to realize a keyword detection unit that detects a keyword included in an uploaded document that is a document uploaded to a document management system that manages the document, wherein
the keyword detection unit executes notification to a specific notification destination that is a specified notification destination in a case where the keyword is included in the uploaded document under a specific condition that is a specified condition, and
at least one of the specific conditions is a condition that all multiple specific keywords that are a plurality of the keywords specified are included in the uploaded document.

8. A document management program that causes a computer to realize:
a document management unit that manages a document; and
a keyword detection unit detects a keyword included in an uploaded document that is the document uploaded to the document management unit, wherein
the keyword detection unit executes notification to a specific notification destination that is a specified notification destination in a case where the keyword is included in the uploaded document under a specific condition that is a specified condition, and
at least one of the specific conditions is a condition that all multiple specific keywords that are a plurality of the keywords specified are included in the uploaded document.
